(19) United States
(12) Patent Application Publication
(10) Pub. No.: US 2003/0014920 A1
(43) Pub. Date: Jan. 23, 2003

(54) Window with multi-way for opening

(76) Inventor: Zhongxuan Lu, Nanning (CN)

Correspondence Address: GREER, BURNS & CRAIN, LTD., Suite 2500, 300 S. Wacker Drive, Chicago, IL, 60606, US

(21) Appl. No.: 10/192,042

(22) Filed: Jul. 10, 2002

(30) Foreign Application Priority Data
Jul. 18, 2001 (CN) 01 2 31708.X

(51) Int. Cl. E05D 15/58

(52) U.S. Cl. 49/254; 49/260

(57) ABSTRACT

The invention discloses a window with multi-way for opening, which can be in pull/push and opened outwards even in pull/push process through elements like sliding pipes etc. There are frame assembly and sash assembly. Each horizontal frame has a cavity with an opening, a guide track for sliding mounted on the bottom slab, and a pair of subsidiary guide tracks provided on the side slabs. Several roller devices are arranged along sliding pipe assembly and matched with the guide track and subsidiary guide track of the horizontal frame. Therefore, the sliding pipe assembly can be moved along the horizontal frame. Furthermore, a hinge assembly fastened to the sliding pipe is provided in one of the stile of sash assembly to be used for supporting rotation of the sash assembly.

### TECHNICAL FIELD OF THE INVENTION

The invention relates to a door and a window for building construction, more particularly, to a window that can be opened through multiple ways such as pushing/pulling, and rotating outwards by using the slide pipe assembly etc.

### BACKGROUND OF THE INVENTION

Windows in modern architecture are provided with better transparent and ventilation function. The window designs commonly seen in prior art are that can be rotated outwards or can be pushed/pulled along the slide ways. However, both of the those windows in prior art have their advantages and drawbacks, for example, push and pull window has an attractive appearance and no space needed to be occupied for its opening, but it has small open region so as to lead unsatisfied indoor lighting and air ventilation. The rotated window although has some advantages such as large open region, and simple structure, convenience in fabrication and installation etc, this type of window is unable to realize air guide function due to the restriction of its outward rotation angle. In addition, it has relative poor stability, which can be evidently proved by the fact that dropping-out of the sash under windy condition is quite often happened. Moreover, the above-mentioned two type of windows in prior art are commonly of the unsafe and inconvenient problems in cleaning of outside on the sash and disability in guiding the air.

In the aspect of building material, aluminum alloy, insulating shaped aluminum or plastic steel laminate etc are commonly used in modern windows. However, these three kinds of construction materials have their defects respectively, e.g. the aluminum alloy material has higher heat-transfer character, and it is easily to dew during the winter season. Plastic steel laminate has poor weather stability and dirty resistance. Therefore, the plastic steel laminate is easy to be deformed and discolored in the region with greater margin of temperature variation, which leads to degradation of its sealing performance. The application of the insulating shaped aluminum need a large quantity of material consumption and a high costs so it is not suitable to be widely used in the construction.

### SUMMARY OF THE INVENTION

An object of the invention is to provide a window with double track frame elements, wherein a slide pipe mounted on the sash assembly to be able to slide along the frame element is matched with the guide track disposed respectively on the double track frame to realize the window to be opened and closed by pushing and pulling; the hinge assembly mounted in the stile of sash assembly realizes the window assembly to be opened outwards at any angle in all position of its push and pull travel, while the outward rotating angle can reach 180 degrees.

The present invention provides a window with multi-way for opening, comprising a frame assembly fastened in a window opening of a structure, provided with a pair of horizontal frames section having a predefined length, installed in parallel at a distance; and a pair of vertical frames section having a predefined length, installed between the pair of horizontal frames in parallel to form an enclosed frame; at least two sash assembly for fastening glass medium and matching with the frame assembly to realize closing and opening of the window, being respectively provided with a pair of rails for matching with the pair of horizontal frames; and at least two stiles for matching with said pair of vertical frames, formed an enclosed sash by arranging to be perpendicular with the rails, wherein each horizontal frame section is provided with two parallel-installed horizontal frames, each of which forms a cavity with a top opening respectively, comprising a bottom slab, provided with a guide track used for sliding; and two side slabs; the window comprises a pair of sliding pipe assembly matching with each sash assembly, each of which comprises a sliding pipe, sliding along the cavity of the horizontal frame; and a hinge assembly, fastened on the sliding pipe, for installing in one of the stiles to sustain rotation of the sash. A roller device is preferably provided on the sliding pipe in order to slide easily along the frame, comprising a roller support, of which bottom is provided with an opening, and top is fastened with the sliding pipe via a location hole; and two sides section, having an aligned location hole respectively; a roller, of which pivot is fastened to the aligned location holes of both sides respectively for matching with said guide track; and a regulator for regulation of matching between the roller and the guide track, penetrating through the sliding pipe and pressing on the top of the roller support.

At least a roller device provided near the end of the sliding pipe properly comprises a roller seat having a opening at its bottom, of which top is fastened onto the sliding pipe via location holes; and two sides section, respectively provided with a pair of sliding slots aligned to each other; a roller support, mounted in the roller seat, of which bottom is provided with a opening, and top is fastened onto the sliding pipe via location holes; and two sides section, provided with a location hole respectively, each of which is aligned with said sliding slot; a main roller for matching with the guide track provided on the bottom slab, of which pivot is fastened onto the sliding slots of both sides of the roller seat; two subsidiary rollers for matching with the pair of subsidiary guide tracks, symmetrically provided on outsides of both sides of the roller seat; a regulator, penetrating through the sliding pipe and the roller seat and pressing on the top of the roller for adjusting vertical separation between the main roller and the subsidiary rollers.

The parallel-installed horizontal frames are staggered, and an outer side slab of each horizontal frame is provided with a slant part for inclining inwards to be used to connect to the top slab provided with an opening. A pair of subsidiary guide tracks is therefore provided in the cavity of the horizontal frames by fastened onto the side slab/top slab of the horizontal frame.

A location device is provided on the sliding pipe comprises a bolt, matching with a location hole on the slide pipe and extends into said sliding pipe; a pressed-block provided at the end of the bolt, having a recess to match with the guide track of the horizontal frame for adjusting tightness and fastening the sliding pipe assembly.

A rotary arm assembly matching with each sash assembly is used for supporting the window opened outwards and is provided with first slideway, fastened on the top of the sliding pipe, in which first slide block is provided; second slideway, fastened to the bottom of the sash, in which second slide block is provided; a stand bar, each of which end is hinged with the first slideway and the slide block inside the second slideway respectively; a pivoted arm, each of which end is hinged with a pre-determined position of the stand bar and the first slide block inside said first slideway respectively. The stand bar is particularly provided as a curvilinear swell from both ends to the middle extending outwards. A sliding block knob is needed to stop the first slide block.

The hinge assembly to be adapted with the sash assembly further comprises a hinge sleeve rotating relative to the hinge, integrally provided with a sleeve, provided in the stile, and being inserted by the hinge; a rod, provided in the rail for bringing the sash assembly into rotation. The top of hinge assembly is fastened by a sleeving, and then an axial bush is inserted by the hinge to be used for supporting the hinge sleeve.

At least a locking pin assembly is provided in an end of the other stile, comprising a base frame with keyway, having a base formed at the inner part of the keyway and protruded from inside wall; a pin element with a cavity, provided with a body for being adapted with the base, on which a protrusion is provided at the outer end for being associated with the outer part of the keyway; and a body extension, penetrating through a central hole on the top of the base frame; a spring, provided at the inner part of the keyway to press on the protrusion of the pin element for resetting the pin element; and a movable block sliding along the cavity of the pin element, pulled by bracing wires.

A handle means for locking is used to adapt with the locking pin assembly for locking the window, comprising a platen, provided at a predefined position on the outer surface of the stile; a recess provided at the frond of the platen; a supporting seat, located at an end of the recess; a rotary handle for locking, adapted with the recess, fastened onto the supporting seat utilizing a flat shaft; a rotary bracket, provided at the inner surface of the platen, matching with the flat shaft to link following the rotary handle, being provided with two cavities with openings, parallel-installed, on which a penetrating slot is provided respectively for arranging the bracing wires connected to the moving block inside the cavity of the pin element; and a roller means, fastened onto the back of the platen via a support, by which a moving block is connected to the handle.

According to an aspect of the invention, since the sliding pipe assembly is applied in the invention, the window thus can be simultaneously opened outwards in while the sash being pushed/pulled in the invention. Thus, the user may optionally adjust the open region and angle within the range of the window; the indoor air input and air inlet direction may be adjustable thereby.

According to another aspect of the invention, the application of the present rotary arm assembly realizes the window to open outwards and rotate at 180 degree. It is convenient for indoor cleaning on both sides of the window and air guide function for the user can be also realized. Therefore, dangerous operations while cleaning the window of buildings have been ideally avoided.

According to a further aspect of the invention, since the location pin assembly is provided in both top and low ends of the stile in the invention, it ensures that the window of the invention can be slowly inserted into the recess for closing and prevent the window glass from being broken in the windy season; on the other hand, four corners of the present sash assembly are respectively locked while closing, its sealing and anti-theft performance is excellent.

According to a further aspect of the invention, a layer of plastic sectional material, e.g. PVC material, is coupled with the inside of the window, not only the rigidity requirement of the window in the invention may be met, but also sound or thermal insulation and heat reserving effects can be better.

### BRIEF DESCRIPTION OF THE DRAWINGS

The present invention will become more apparent as the disclosure of the present invention is made with reference to the accompanying drawings.

FIG. 1A is a perspective view of the window of the present invention, showing that the window of the invention can be pushed/pulled and opened outwards;

FIG. 1B is a longitudinal cross section view of a window shown in FIG. 1A;

FIG. 2 is a perspective view of partial horizontal frame section of the frame assembly of the present invention, showing that a guide track and a pair of subsidiary guide tracks is disposed in the cavity of each horizontal frame respectively;

FIG. 3A is a perspective view of partial left side vertical frame section of the present invention, in which a support for fastening top wool is provided on the side slab of inner frame;

FIG. 3B is a perspective view of partial right side vertical frame section of the present invention, in which a support for fastening the strip is provided on the side slab of outer frame;

FIG. 4A is a perspective view of partial rail matched with the inner frame of the present invention;

FIG. 4B is a perspective view of partial rail matched with the outer frame of the present invention;

FIG. 5 is a perspective view of partial stile for containing the locking pin assembly of the present invention;

FIG. 6A is an exploded perspective view of partial stile for containing the hinge assembly matched with the outer frame of the present invention, showing that the end cover and the main body are in movable connection;

FIG. 6B is an exploded perspective view of partial stile for containing the hinge assembly matched with the inner frame of the present invention;

FIG. 7A is a front view of the present window of FIG. 1A in closed state;

FIG. 7B is an enlarged cross sectional view of the present window taken along B-B line of FIG. 7A;

FIG. 7C is an enlarged cross sectional view of the present window taken along A-A line of FIG. 7A;

FIG. 8A is a perspective view of the sliding pipe of the present invention, showing that the hinge is fastened on the sliding pipe;

FIG. 8B is cross sectional view of the sliding pipe taken along C-C line of FIG. 8A;

FIG. 8C is a cross sectional view of the sliding pipe taken along D-D line of FIG. 8B;

FIG. 9A is a schematic view of assemblage of an adjustable roller and the sliding pipe;

FIG. 9B is a partial cross sectional view of the adjustable roller of FIG. 9A, showing the side of roller;

FIG. 9C is a top view of the adjustable roller of FIG. 9B;

FIG. 9D is an assemble schematic view of the adjustable roller of FIG. 9A and the sliding pipe and horizontal frame of the present invention;

FIG. 10A is an assemble schematic view of the tri-axial adjustable roller and the horizontal frame and sliding pipe of the present invention;

FIG. 10B is a partial cross sectional view of the tri-axial adjustable roller and sliding pipe of the present invention;

FIG. 10C is a top view of the adjustable roller of FIG. 10B;

FIG. 11 shows a location device of the sliding pipe assembly of the present invention;

FIG. 12A is a assemble schematic view of sliding pipe assembly and sash assembly of the present invention;

FIG. 12B is a perspective view of the hinge sleeve of FIG. 12A;

FIG. 13A is a schematic view of the rotary arm assembly of the present invention, in which two slideways are in perpendicular positions;

FIG. 13B is a partial cross sectional view of the rotary arm element along E-E line of FIG. 13A;

FIG. 13C is a schematic view of the rotary arm assembly of the present invention, in which two slideways are fully opened to be at angle of 180 degree;

FIG. 14A is a front view of the handle means for locking of the present invention;

FIG. 14B is a assemble schematic view of the handle means of FIG. 14A and the locking pin assembly, showing that the sash assembly is in open state;

FIG. 14C is a cross sectional view of the handle means taken along F-F line of FIG. 14B;

FIG. 15A is a longitudinal cross sectional view of tension assembly of the present invention;

FIG. 15B is a top view of the tension assembly of FIG. 15A;

FIG. 16 shows another preferred embodiment of the horizontal frame of the present invention, in which a decorative frame made of plastics sectional material is coupled with the inside slab of horizontal frame by rolling technology;

FIG. 17 is another preferred embodiment of vertical frame of the present invention, in which the decorative frame made of plastics sectional material is coupled with the inside slab of vertical frame by rolling technology;

FIG. 18 is another preferred embodiment of the rail of the present invention, in which the decoration part is coupled with inside slab of the rail by rolling technology;

FIG. 19 is another preferred embodiment of the stile of the present invention, in which the decoration part is coupled with inside slab of the stile by rolling technology.

### THE DETAILS OF THE INVENTION

The structures of upper sash assembly and upper horizontal frame section are respectively as the same as that of lower sash assembly and lower horizontal frame section, the lower sash assembly and lower horizontal frame section are set forth hereinafter by reference.

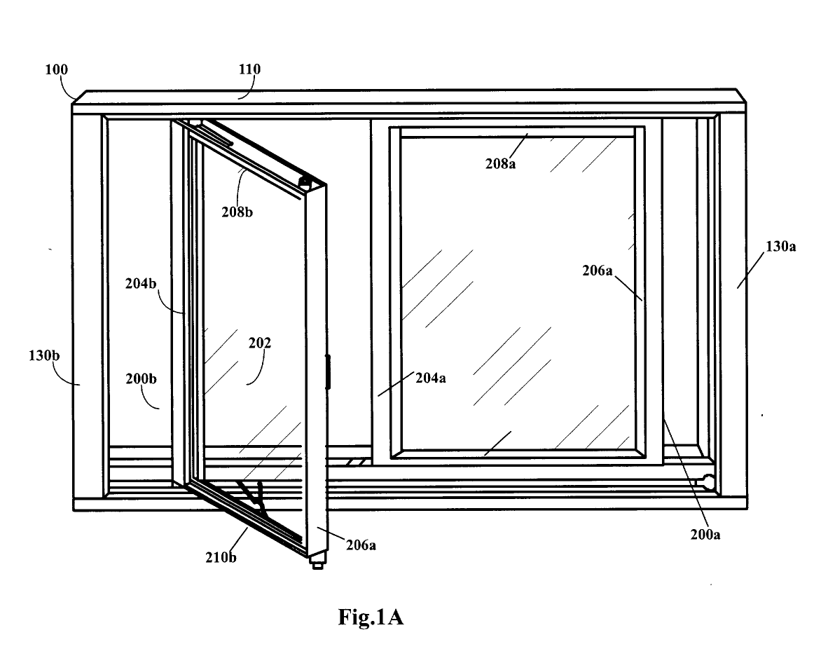

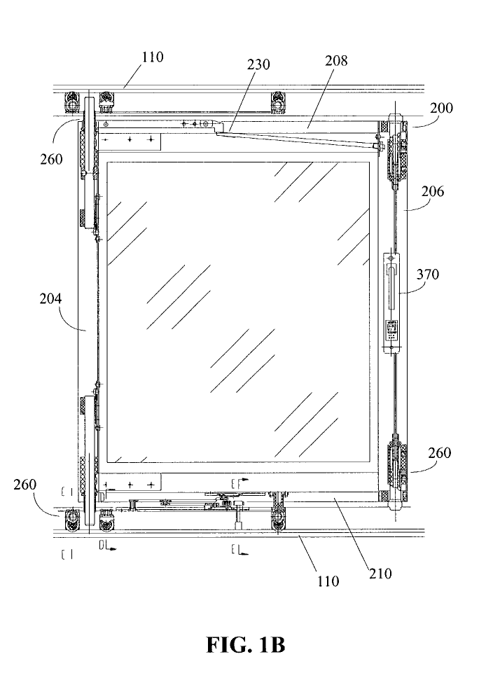

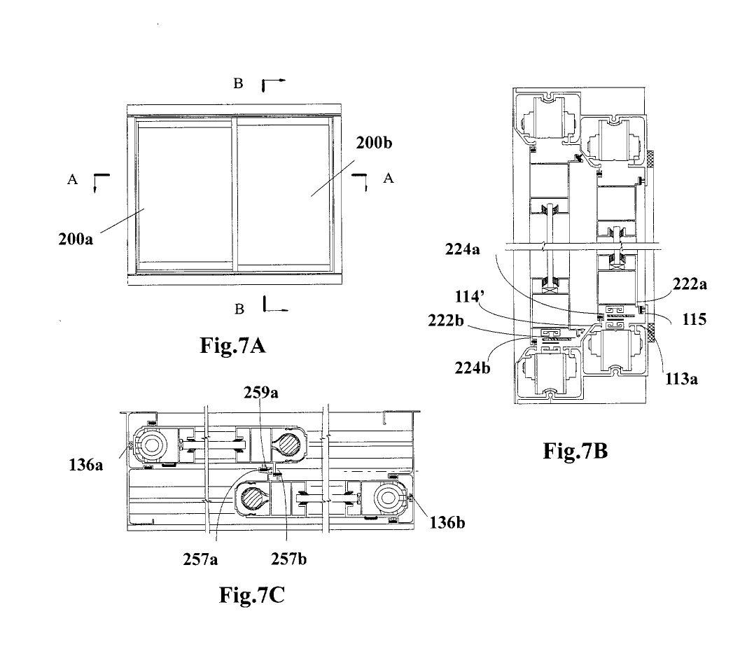

It can be seen from the perspective view of the present window having a double frame assembly 100, as shown in FIG. 1A, in which the outer sash assembly 200b is opened outwards, and the inner sash assembly 200a is opened by push/pull manner. The frame assembly 100 comprises a pair of horizontal frame sections 110 and a pair of vertical frame sections 130, matching with the window opening of the structure (not shown). The sash assembly 200(a, b) for fastening glass medium comprises an the stile 204(a, b) for containing a hinge; a stile 206(a, b) for containing a locking pin assembly; an upper rail 208(a, b); and a lower rail 210(a, b). A plan schematic view of the sash assembly 200(a, b) in fully closed state refers to FIG. 7A.

Referring to FIG. 1B, the sliding pipe assembly 260(a, b) can slide along the horizontal frame section 110 and is installed on the upper rails 208(a, b) and the lower rails 210(a, b). In addition, a tension assembly 230(a, b) is also provided inside the upper rail 208(a, b) for tightening the sash assembly 200(a, b) to enhance stability according to the present invention. Hence four corners of each sash assembly 200(a, b) of the present invention is locked under fully closed state.

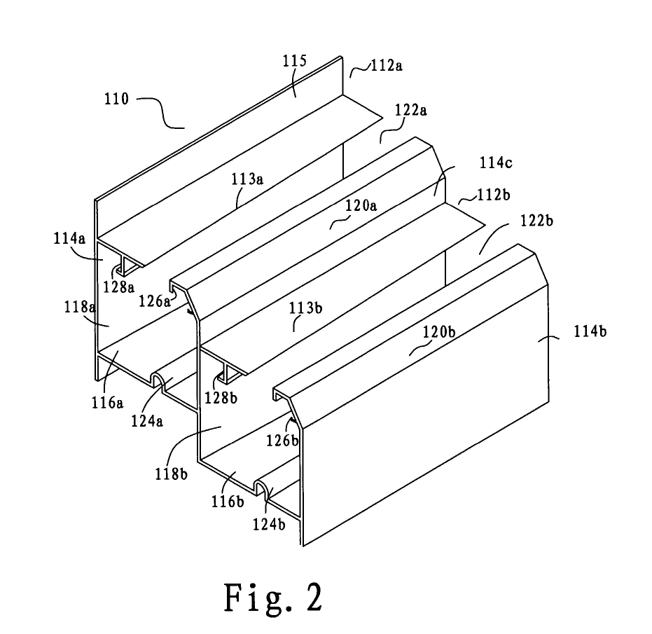

The horizontal frame section 110 is provided with two parallel-installed horizontal frames 112a and 112b. Referring to FIG. 2, the two parallel-installed frames 112a and 112b are staggered to each other, and the inner horizontal frame 112a is slightly higher than the outer horizontal frame 112b. The horizontal frames 112(a, b) has a cavity 118(a, b) and are primarily isolated by common slab 114c, comprising a top slab 113(a, b); a side slab 114a or 114b; and a bottom slab 116(a, b). The top slab 113(a, b) is provided with an opening 122(a, b); a bottom slab 116(a, b) is provided with a guide track 124(a, b). Particularly, a pair of subsidiary guide tracks 126(a, b) and 128(a, b) of the present invention are mounted within the cavity 118(a, b), for example, it can be mounted to the side slabs 114(a, b) or top slab 113(a, b) respectively. In order to guide the sash assembly 200 to be closed easily, a slant slab 120(a, b) is formed between the top slab 113a and the common slab 114c or the top slab 113b and the outer side slab 114b, preferably, the oblique of the slant slab 120(a, b) is 45 degree. Moreover, the side slab 114a of inner horizontal frame 112a extends outwards to form a slab extension 115, used for matching with the strip (not shown).

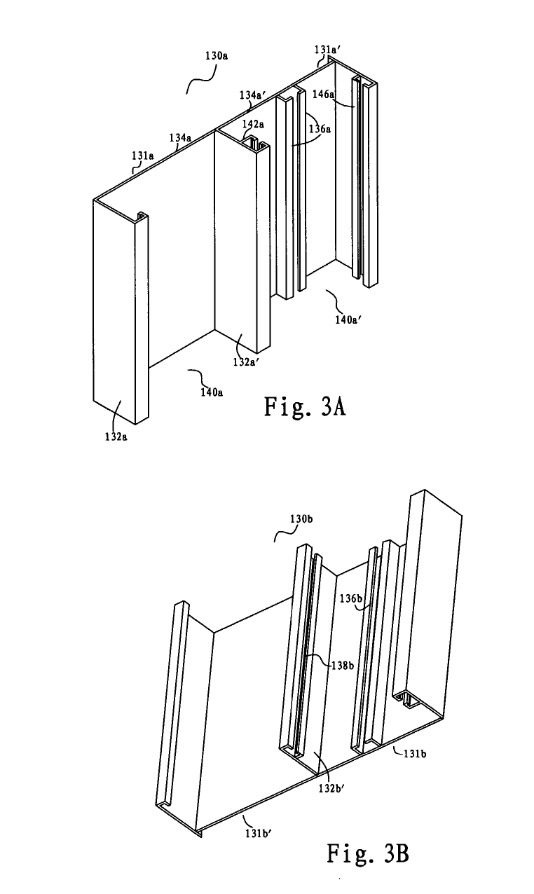

FIG. 3A shows the left side vertical frame section 130a which has two parallel-installed vertical frames 131a and 131a′. Firstly, the vertical frames 131a and 131a′ are isolated by the element 132a′. Each vertical frame 131a or 131a′ has a cavity 140a and 140a′; an element 132a or 132a′; and a side slab 134a or 134a′. A pair of supports 136a on the side slab 134a′ are separated at pre-determined distance for mounting plastic strip (not shown) to buffer the impaction force of sash assembly 200b in push and pull, as shown in FIG. 7C. Meanwhile, a pair of supports 142a and 146a are also separated at pre-determined distance on the element 132a and 132a′ of outer vertical frame 131a′ for fastening the top wool to seal the window together with the sash assembly 200b.

FIG. 3B shows the right side vertical frame section 130b, of which two vertical frame 131b and 131b′ is isolated by an element 132b′. The difference is that the support 136b for fastening plastic strip (not shown) to buffer the impaction force and a pair of supports 138b for fastening top wool (not shown) to seal the window are provided in the inner vertical frame 131b.

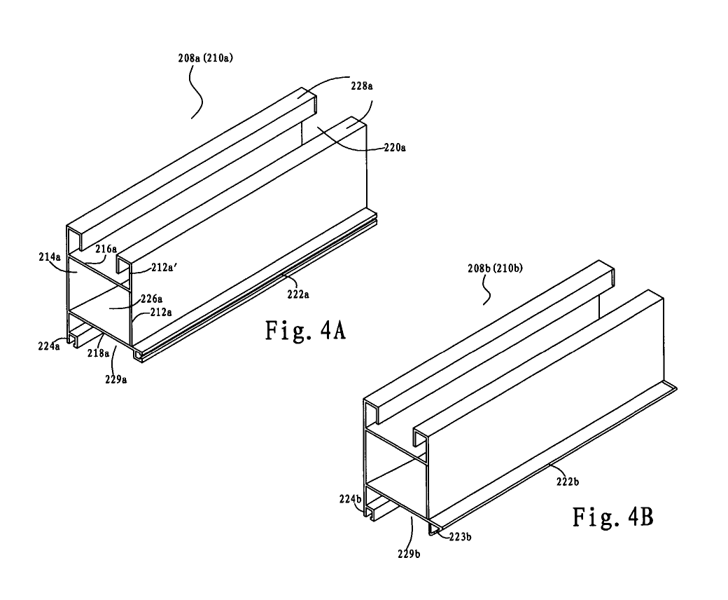

FIG. 4A is a perspective view of the rail 208a matched with the inner horizontal frame 112a, which comprising an inner slab 212a and a outer slab 214a, the separation between them should adapt with the cavity 140b of the vertical frame 130a; upper slabs 216a and lower slab 218a, forming a chamber 226a together with the slabs 212a and 214a; a pair of fasteners 228a for fastening glass 202, being formed by an extension part 212a′ and 214a′ which are extended upwards from a pair of the slabs 212a and 214a, and form a spacing 220a by bending inwards. A pair of supports 224a are fastened on the extension part of the slab 214a, which extends downwards for mounting top wool (not shown) to match with the top slab 113a of inner horizontal frame 112a, as shown in FIG. 7B. Another pair of supports 222a, are fastened on the extension part of the slab 218a, which extends inwards for mounting top wool (not shown) to match with the slab extension 115 of horizontal frame 118, as shown in FIG. 7B. A space 229a is formed between two pair of the supports 222a and 224a.

FIG. 4B is a perspective view of the rail 208b matched with the outer horizontal frame 112b of the present invention, its structure is substantively as the same as that of the rail 208a. The difference is that a pair of supports 222b on an extension part is formed to be triangle; the top wool (not shown) on it matches with the slant slab 120a.

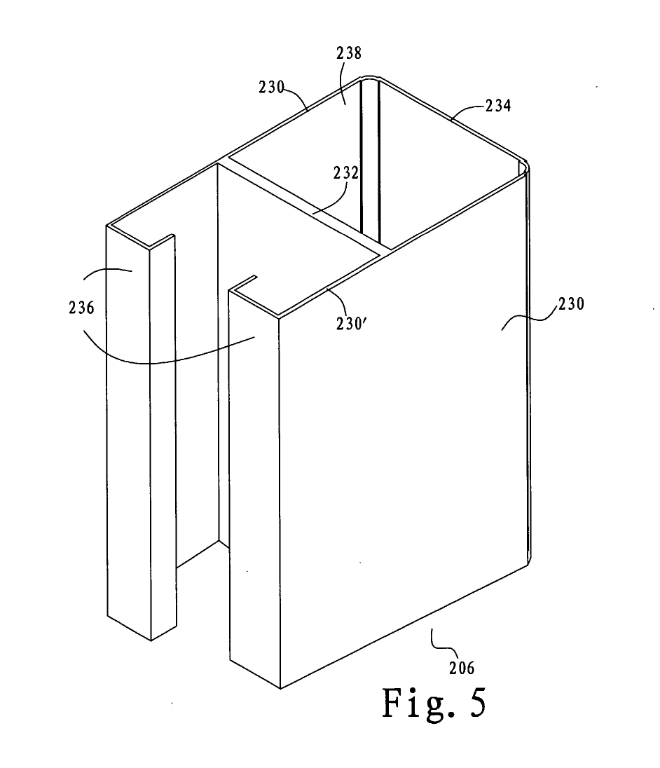

The stile 206(a, b) for containing locking pin assembly is integrated according to the present invention, as shown in FIG. 5. It comprises a pair of side slabs 230, which are simply separated to adapt the cavity 140(a, b) of the vertical frame 130(a, b); a vertical slab 232; an end cover 234, forming a chamber 238 with a pair of side slabs 230 and the vertical slab 232; and a fastener 236, formed by a extension part of the slab 230 being bending inwards.

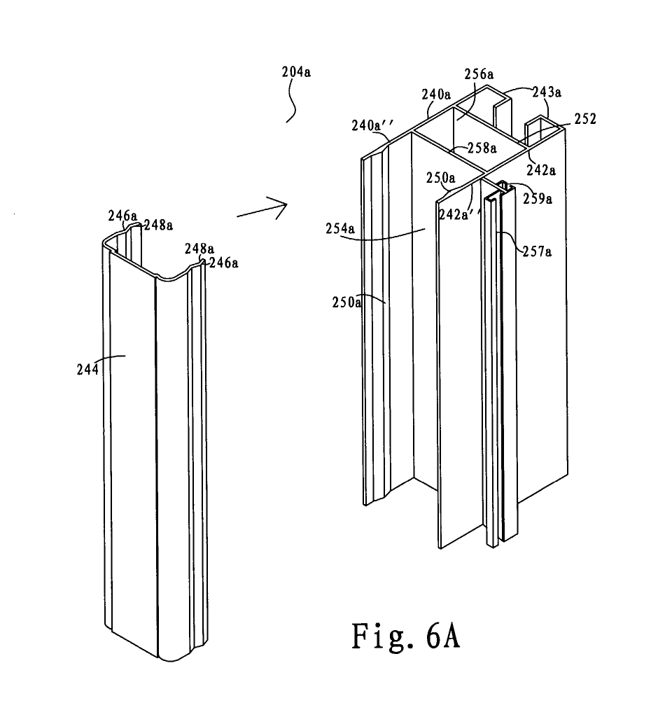

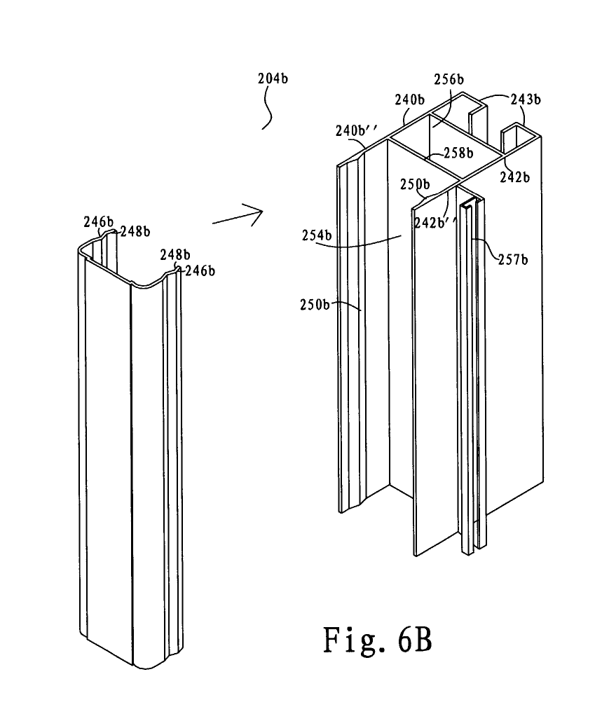

An end cover and a main body of the stile for containing the hinge assembly are in movable connection in order to be convenient for mounting and maintain operation. Referring to FIG. 6A, the stile 204a is matched with the inner vertical frame. Two extension parts 240a″ and 242a″ are respectively formed by the side slabs 240a and 242a extending outwards. A arris 250a is provided near the end of each extension parts 240a″ and 242a″; the recess 246a is therefore formed near each end 248a of cover 244a to match with each arris 250a. Particularly, the end 248a should be slightly bended inwards in order to be convenient for connection. A fastener 243a is formed by extension parts of the side slabs 240a and 242a bending inwards for fastening glass medium 202. In addition, the vertical slab 252 divides the inside of the stile 204a into spaces 254a and 256a. Particularly, a lap joint 257a is provided on the side slab 242a of the stile 204a to seal the overlapped part between the inner and outer sash assembly by top wool. In addition, a fastening support 259a is also provided on the side of the lap joint 257a for fastening plastic strip.

While the difference between the stile 204b matched with the outer vertical frame and the above stile 204a is that only a lap joint 257b is provided on the side of the stile 204b, as shown in FIG. 6B. Thus, when two sash assembly are pulled/pushed to close, fastening support 259a with plastic strip on the inner sash assembly can buffer the impact from the lap joint 257b, and can seal the overlapped part at meantime.

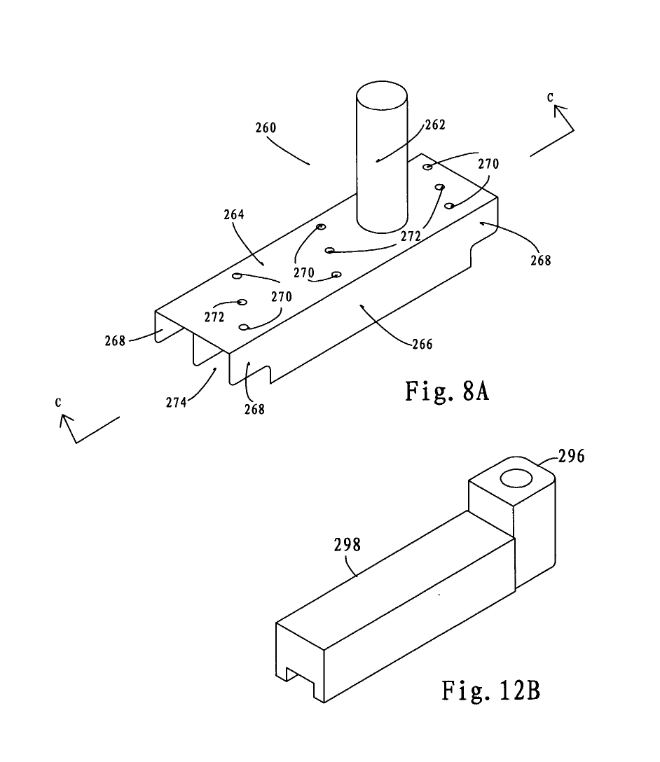

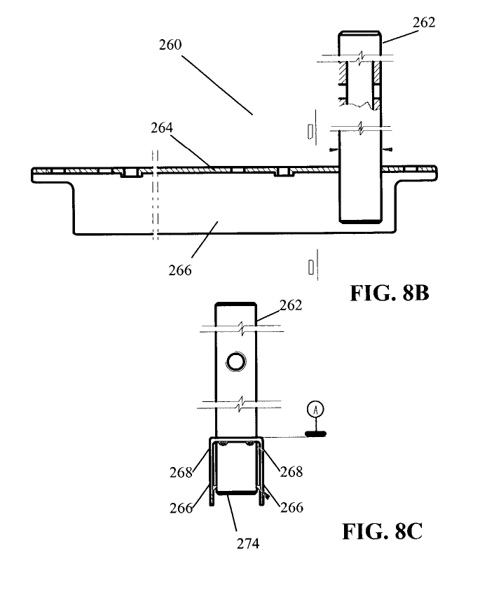

FIG. 8A shows a perspective of sliding pipe assembly 260 with the adjustable roller being removed. The sliding pipe assembly 260 comprises a sliding pipe 264, having a pair of side wall 266 with sunken ends 268, on which several mounting holes 270 and regulating holes 272 for fastening the roller supports (not shown) etc. are provided; a hinge 262, is mounted on the top of sliding pipe 264; and a space 274, being used for mounting the adjustable rollers of the present invention. It can be seen from FIG. 8B and 8C, the hinge 262 penetrates the sliding pipe 264, and is in rigid connection with the pipe.

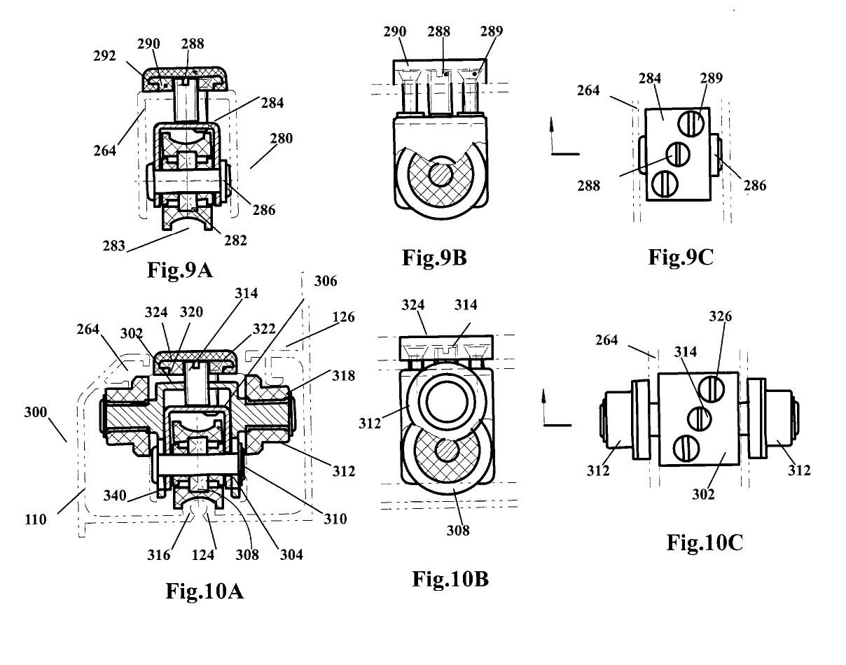

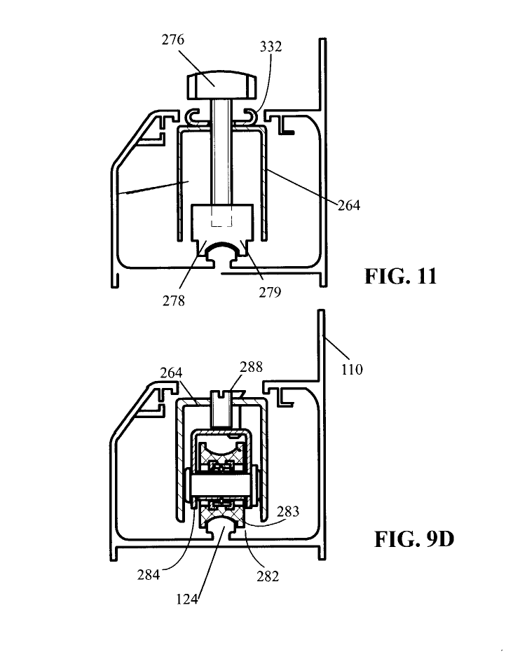

It is understood that a plenty of sliding means can be applied in the present sliding pipe assembly to realize the movement along the guide track on the horizontal frame. The schematic view of the preferred embodiment of the sliding means is shown in FIGS. 9A-9C. The roller device 280 is installed in the space 274 of sliding pipe 264, and comprises a roller support 284, of which bottom is provided with an opening, top is fastened with the sliding pipe 264 via a location hole, and two side sections have an aligned location hole respectively; a roller 282, of which a pivot is fastened to the aligned location holes of both side sections for matching with the guide track 124; and a regulator 288 for regulation of matching between the roller and the guide track, penetrating through the sliding pipe 264 and pressing on the top of the roller support 284. Preferably, a sliding slot 283 should be provided on the roller 282. Meanwhile, a pad 290 is also provided on the sliding pipe 264 to support the middle of the sash assembly. The pad 290 has several holes, which can be penetrated by the location elements 289 and regulator 288; and a shoulder 292. From a schematic view of position relationship between the adjustable roller device 280, sliding pipe 264 and horizontal frame 110 as shown in FIG. 9D, the height of roller support 284 may be regulated via regulator 288, thereby roller 282 can match well with the guide track 124.

More particularly, a pair of tri-axial roller devices 300 is provided on both ends of the sliding pipe 264 in accordance with the present invention, to improve the stability of sliding pipe assembly 260, as shown in FIGS. 10A-10C, it is also provided in space 274. Firstly, a roller seat 302 is provided thereof and is fastened to the sliding pipe 264 by the location holes of the top, having an opening on the bottom and having two aligned sliding slots 304 on two side sections. A roller support 306 is then mounted in the roller seat 302 and is also fastened to the sliding pipe 264 by the location holes of the top, having an opening on the bottom and a pair of mounting holes on two side sections. The mounting holes are aligned with the sliding slots 304 respectively. A main roller 308 to be matched with the guide trace 124 of FIG. 2 can be therefore fastened with the mounting hole by its pivot 310. Obviously, the pivot 310 can be also movable along the sliding slots 304 when the roller support 306 is regulated. The tri-axial roller device 300 also comprises two subsidiary rollers 312 to be used for matching with the pair of subsidiary guide tracks 126 and 128 provided in horizontal frame 110 of FIG. 2. The subsidiary rollers 312 are symmetrically mounted outside two side sections of the roller seat 302. Preferably to minimize the mounting size, the symmetrical central line of a pair of subsidiary rollers 312 should be coincided with the central line of the main roller 308, as shown in FIG. 10B; and the sunken ends 268 of sliding pipe 264 of FIG. 8A should be exactly provided the space between the subsidiary roller 312 and roller 302. A regulator 314 is applied in the tri-axial roller device 300, which is used for adjusting the vertical separation between the main roller 308 and the subsidiary rollers 312 so as to be closely matched with the guide tracks. For example, when the regulator 314 is adjusted downwards, the roller support 306 together with the main roller 308 will move downwards and the vertical separation between the subsidiary roller 312 and the main roller 308 will be accordingly increased. Thus, the rollers can be in close contact with the guide tracks to ensure that the sliding pipe assembly 260 of the present invention can slide stably in horizontal frame 110.

Obviously, the main roller 308 and the subsidiary roller 312 should have sliding slots 316 and 318 to maximize the surface for matching with the guide tracks.

Similarly, as the fulcrum of the window, another pad 320 is also provided on the sliding pipe 264, which has several holes penetrated by the location elements 326 and regulator 314 and a shoulder 322. In addition, a cover plate 324 may be provided on sliding pipe 264, its hook and the shoulder 322 of pad 320 being fastened in matching.

Moreover, it is necessary to consider the demand of the location for the sliding pipe assembly 260, so a location device is disposed thereon. Referring to FIG. 11, a bolt 276 penetrates a hole on the top of sliding pipe 264. A pressed-block 278 is provided at the end of the blot 276, on which a recess 279 is provided to be used for matching with the guide track 124 of FIG. 2. In this way, the sliding pipe 264 will be in removable/immovable state when loosening/locking the blot 276.

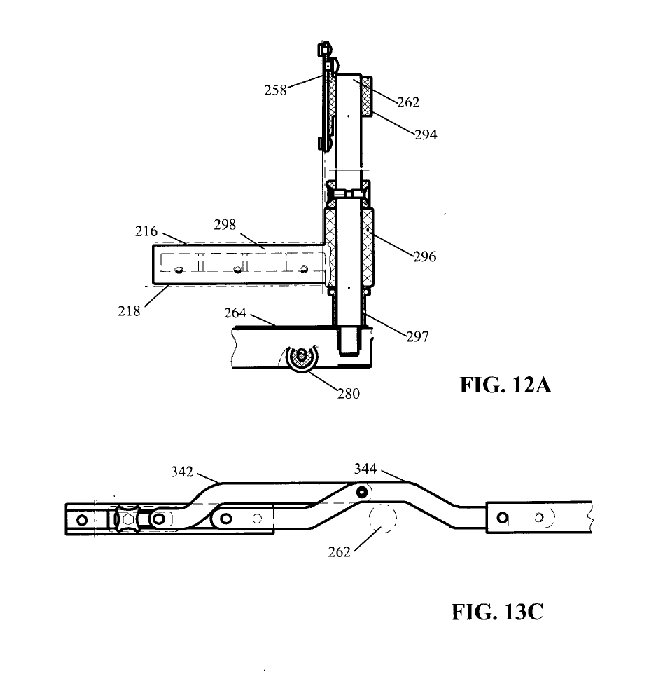

FIG. 12A illustrates the hinge assembly being mounted within the stile 204 of the present invention. The hinge 262 is provided in space 254 of FIG. 6A by a hinge sleeve 296, as shown in FIG. 12B, and can rotary with relation to the hinge sleeve 296. In fact, the present invention composes the rail 208/210 and the stile 204 of the sash assembly 200 by the hinge sleeve 296. Firstly, the sleeve 296 is also provided in the stile 204, and the top of hinge 262 is fastened to the interior of the stile 204, such as a slab 258, by a sleeving 294 after inserting the hinge sleeve 296. A rod 298 is integrated with the sleeve 296 and is provided in the rail 208/210 in order to make the sash assemble 200 into rotation around the hinge 262. Certainly, considering the requirement of mounting, axial bush 297 should be provided between the sliding pipe 264 and the hinge sleeve 296, which may also be used for supporting the hinge sleeve 296. Therefore, it is understood that the end cover 244 in movable connection with the body of the stile 204 is convenient for mounting of the hinge assembly; on the other hand, it is also convenient for maintain operation, that is, the sash assembly 200 can be unloaded easily after removing the end cover 244 when the glass being damaged in accident.

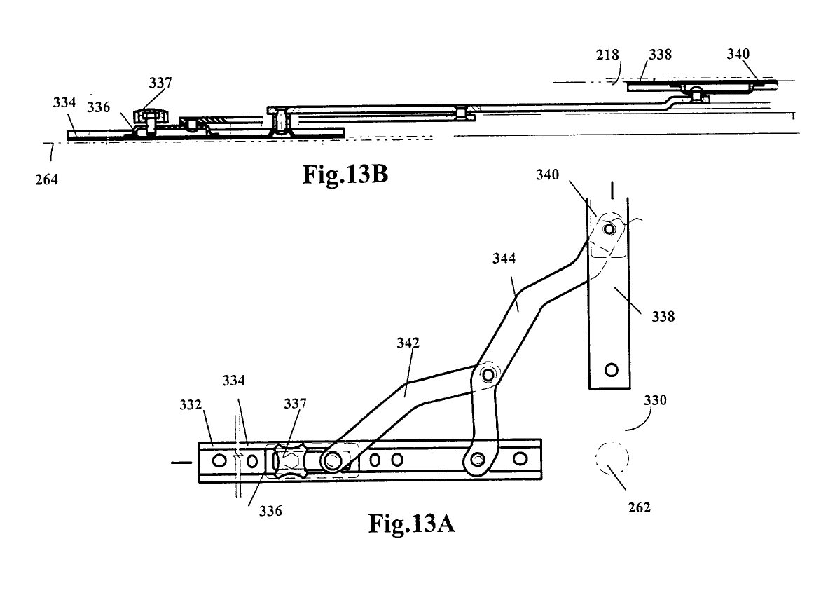

The rotary arm assembly 330 of the present invention can be not only used to fasten the sash assembly 200 opened outwards, but also support the sash assembly rotating to 180 degree. FIGS. 13A-13B shows a state that the window opened to 90 degree. A first slideway 332 is fastened on the top of sliding pipe 264 via location holes on the bottom 334 and is provided with a first slide block 336. A second slideway 338 with a second slide block 340. There are a stand bar 344 and a pivoted arm 342. Both ends of the stand bar 344 are respectively hinged with the first slideway 332 and the second slide block 340 in the second slideway 338. Both ends of the pivoted arm 342 are respectively hinged with a pre-determined position of the stand bar 344 and the first slide block 336 in the first slideway 332. The rotary arm assembly 330 is then locked by a sliding block knob 337 provided on, the first slideway 332 by stopping the first slide block 336.

Since the hinge 262 is provided in the stile 204, the stand bar 344 needs a special design in order to avoid the stop of the hinge 262. According to the present invention, a curvilinear swell extending outward needs to be provided on a pre-determined position; the pivoted arm 342 needs to be bent, preferably at an obtuse angle. In this way, the curvilinear swell part of the stand bar 344 can be just round the hinge 262 and the end of the pivoted arm 342 hinged with the first slide block 336, as shown in FIG. 13C. Thus, the rotary arm assembly of the present invention ensures the sash assembly to be able to opened at 180 degree.

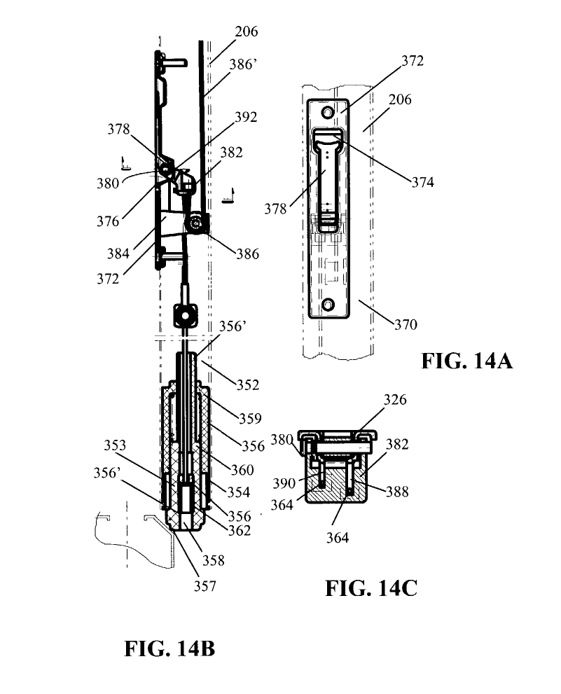

FIGS. 14A-14B illustrate a handle means for locking and a locking pin assembly. In fact, the locking pin assembly 350 of the present invention is respectively provided at upper and lower ends of the stile. The locking pin assembly 350 arranged in the lower end of the stile is set forth by reference hereinafter. Firstly, the locking pin assembly 350 of the present invention matched with the horizontal frame 110 comprises a base frame 352, a pin element 356, a spring 359 and a movable block 362. The base frame 352 has a keyway 353 and a base 354 formed at the inner part of the keyway 353. The pin element 356 has a body for adapting with the base 354, of which the outer end is formed as a protrusion 357 to be matched with outer part of the keyway 358 and a body extension 356′, penetrating trough a central hole on the top of the base frame 352. The spring 359 is provided at the interior of the keyway 353 and pressed on the protrusion 357 of the pin element 356 for resetting the pin element. The movable block 362 can be slide along the cavity 358 of the pin element 356 and is pulled by a bracing wire 364 connected to a handle, such as steer wire. When rotating the handle, the movable block 362 acts on the top of the pin element 356 to take the pin element moving upwards, thus, the sash assembly 200 can be smoothly reset to the horizontal frame 110. When loosening the handle, the pin element 356 resets under the action of spring 356. Another advantage of the locking pin assembly 350 of the present invention is that the protrusion 357 of the pin element 356 shall impact to the slant slab 120 of the horizontal frame 110 once it happens a strong wind; the spring 359 is then compressed by external force and finally locks the sash assembly after the sash assembly resets into the horizontal frame 110. Furthermore, the pin element 356 of the present invention can be not only used to lock the window, but act as a guide action as well in push and pull.

The handle means for locking 370 comprises a platen 372, a rotary handle 378, a rotary bracket 382 and a roller means 386. The platen 372 is arranged at a predefined position on the outer surface of the stile 206. Meanwhile, a recess 374 is formed at the front of the platen 372, a supporting seat 376 is arranged at an end of the recess 374. The rotary handle for locking 378 is substantively adapted with the recess 374 and fastened to the supporting seat 376 by its axle 380. The rotary bracket 382 is provided at the back of platen 372 and fastened to the ends of the axle 380 outside the supporting seat 376, having two cavities 388 and 390 with opening. In fact, the rotary bracket 382 can be driven by the handle 376 through the axle 380. Preferably, the axle 380 is a flat axle. The roller 386 is mounted on the back of platen 372 and positioned below the rotary bracket 382.

One of bracing wires 364 which is connected to the moving block 362 in the lower locking pin assembly is arranged in the cavity 388, and the other which is connected to the moving block 362 in the upper locking pin assembly is arranged in the cavity 390. Obviously, the guide slot for arranging the bracing wire is aligned to the opening of the cavity 390. In addition, a torsion-bar spring 392 is provided to depend on the rotary support 382 for resetting the handle.

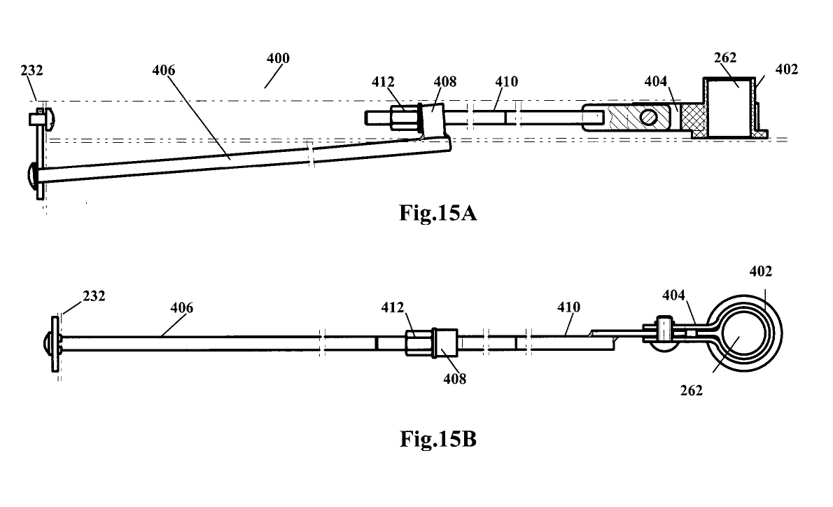

In general, the sash assembly with glass medium shall be normally relative heavy, therefore, if the sash assembly 200 of the present invention is simply maintained by the upper and lower hinge assembly 260, the deformation of frame assembly will be easily generated after being used for a certain time, thereby it can not be effectively used for a long time as required. Therefore, a tension assembly needs to be arranged for improving the rigidity of the frame assembly 100, as shown in FIGS. 15A-15B. The tension assembly 400 of the present invention is provided in the upper rails. An axial bush 402 is located above the hinge sleeve 296 and is also inserted by the hinge 262. A pipe hoop 404 is fastened to the axial bush 402 through one of ends. A tension brace 406 is fastened to the vertical slab 232 of the stile for containing the locking pin assembly and is provided with a ring 408 on the end. Meanwhile, a connecting piece 410 is fastened to the other end of the pipe hoop 404 and passing through the ring of the tension brace 406. Next, a fastenings 412 is provided on the end of the connecting piece 410 for tightening the tension brace 406. In this way, the sash assembly will be kept in good working order due to stability improvement whenever the sash assembly 200 of the present invention is in pull/push or opened outwards.

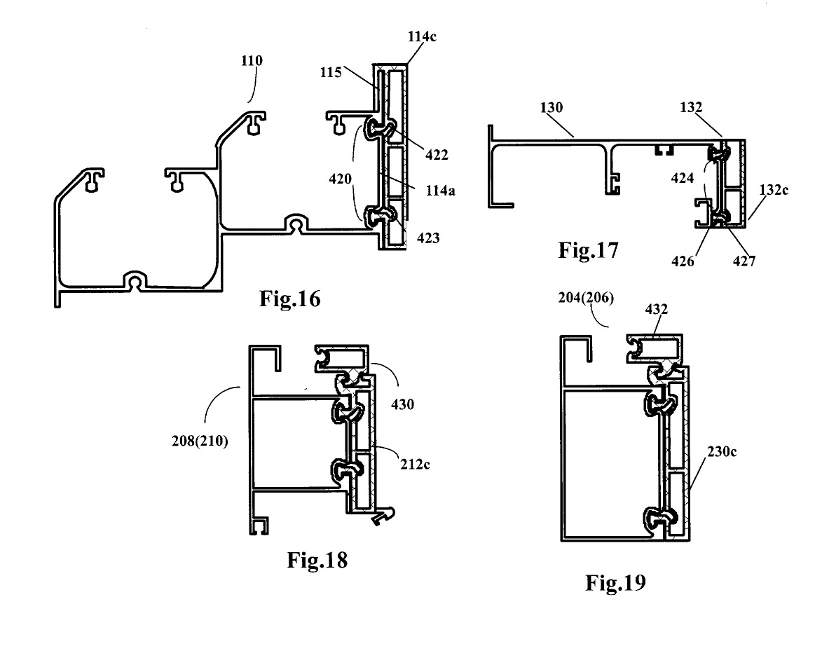

With respective to the present sash assembly and frame assembly, it is available to have engineering plastics, e.g. PVC material, coupled to the inside of the sash assembly and frame assembly made of metal material so that the heat-insulting property of the present window can be improved. It is known that sound insulation value for the engineering plastics is also significant. Therefore the above advantage of the present sash and frame assembly coupled with the engineering plastic is obvious while application in those north areas. FIGS. 16-17 respectively show the coupled horizontal and vertical frame sections of the present invention. Firstly, a slot 420 is evenly arranged along the length of inner side slabs 114a and 115a of horizontal frame 112a. Correspondingly, a bending projection 422 integrated with the plastic sectional material is closely coupled with the slot 420 through rolling technology. Similarly, a slot 424 is also provided on the inner side 132 of the coupled vertical frame and is coupled with a bending projection 426 integrated with the plastic sectional material through rolling technology.

FIGS. 18-19 is respectively cross section view of the coupled rail and stile. The coupled structure of the rail and stile is substantively as the same as that of frame section, and its structure is no longer described. However, the difference is only that a pressure element 430 and 432 is in lock joint with the plastic sectional material coupled with the rail/stile for compacting glass medium thereof is needed.

While the specific embodiments have been illustrated and described, numerous modifications come to mind without significantly departing from the spirit of the invention and the scope of protection is only limited by the scope of the accompanying Claims.

What is claimed is:

1. A window with multi-way for opening comprising
a frame assembly fastened in a window opening of a structure, provided with
a pair of horizontal frames section having a predefined length, installed in parallel at a distance; and
a pair of vertical frames section having a predefined length, installed between the pair of horizontal frames in parallel to form an enclosed frame;
at least two sash assembly for fastening glass medium and matching with the frame assembly to realize closing and opening of the window, being respectively provided with
a pair of rails for matching with the pair of horizontal frames; and
at least two stiles for matching with said pair of vertical frames, formed an enclosed sash by arranging to be perpendicular with the rails, wherein
each horizontal frame section is provided with two parallel-installed horizontal frames, each of which forms a cavity with a top opening respectively, comprising
a bottom slab, provided with a guide track used for sliding; and
two side slabs;
the window comprises a pair of sliding pipe assembly matching with each sash assembly, each of which comprises
a sliding pipe, sliding along the cavity of the horizontal frame; and
a hinge assembly, fastened on the sliding pipe, for installing in one of the stiles to sustain rotation of the sash.

2. A window according to claim 1, wherein several roller devices, arranged along the sliding pipe, for matching with the sliding guide track provided on the bottom slab, each of which comprises
a roller support, of which bottom is provided with an opening, top is fastened with the sliding pipe via a location hole, and two sides sections have an aligned mounting hole respectively;
a roller, of which a pivot is fastened to the aligned location holes of both sides respectively for matching with said guide track; and
a regulator for regulation of matching between the roller and the guide track, penetrating through the sliding pipe and pressing on the top of the roller support.

3. A window according to claim 2, wherein a pad for supporting is provided on the sliding pipe as a fulcrum on the middle of window, comprising
several holes, used for positioning and penetration of the regulator; and
a shoulder, swelling outwards from both sides.

4. A window according to claim 1, wherein the parallel-installed horizontal frames are staggered in lengthwise direction.

5. A window according to claim 4, wherein an outer side slab of each horizontal frame is provided with a slant part for inclining inwards to be used to connect to the top slab provided with an opening.

6. A window according to claim 5, wherein a pair of subsidiary guide tracks are also provided in the cavity of the horizontal frames, located at both sides of the guide track and fastened onto the slab or top of the horizontal frame.

7. A window according to claim 6, wherein at least a roller device provided near the end of the sliding pipe comprises
a roller seat, of which an opening is provided on the bottom, the top is fastened to the sliding pipe via location holes, and two side sections are respectively provided with a pair of sliding slots aligned to each other;
a roller support, mounted in the roller seat, of which bottom is provided with a opening, and top is fastened onto the sliding pipe via location holes; and two sides section, provided with a mounting hole respectively, each of which is aligned with said sliding slot;
a main roller for matching with the guide track provided on the bottom slab, of which pivot is fastened onto the sliding slots of both sides of the roller seat;
two subsidiary rollers for matching with the pair of subsidiary guide tracks, symmetrically provided on outsides of both sides of the roller seat;
a regulator, penetrating through the tops of sliding pipe and the roller seat and pressing on the top of the roller support for adjusting vertical separation between the main roller and the subsidiary rollers.

8. A window according to claim 7, wherein, the symmetrical central line of said pair of subsidiary rollers coincides with the central line of said main roller.

9. A window according to claim 1, wherein a location device is provided on the sliding pipe, comprises
a bolt, penetrating a location hole on the sliding pipe and extends into said sliding pipe;
a pressed-block provided at the end of the bolt, having a recess to match with the guide track of the horizontal frame for adjusting tightness and fastening the sliding pipe assembly.

10. A window according to claim 1, wherein a rotary arm assembly matching with each sash assembly is provided with
a first slideway, fastened on the top of the sliding pipe, in which a first slide block is provided;
a second slideway, fastened to the bottom of the sash, in which a second slide block is provided;
a stand bar, both ends are hinged with the first slideway and the second slide block in the second slideway respectively;
a pivoted arm, both ends are hinged with a pre-determined position of the stand bar and the first slide block in said first slideway respectively.

11. A window according to claim 10, wherein a curvilinear swell extending outwards is provided on a pre-determined position of the stand bar in order to avoid the stop of the hinge, and the pivoted arm is a bent element to be matched with the curvilinear swell part.

12. A window according to claim 10, wherein a sliding block knob is provided on the first slideway to stop the first slide block.

13. A window according to claim 1, wherein the hinge assembly comprises a hinge sleeve rotating with relation to the hinge, integrally provided with
a sleeve, provided in the stile, and being inserted by the hinge;
a rod, provided in the rail for matching the sash assembly into rotation.

14. A window according to claim 13, wherein the hinge assembly also comprises
a sleeving, fastened on a predefined position of the stile for fastening the top of the hinge.

15. A window according to claim 14, wherein an axial bush is provided between the sliding pipe and the hinge sleeve for supporting the hinge sleeve.

16. A window according to claim 14, wherein a tension assembly is provided in the upper rail, comprising
an axial bush, located above the hinge sleeve and being inserted by the hinge;
a pipe hoop, of which one end is fastened with the axial bush;
a tension brace, on which a ring is provided on the end, fastened to the stile for containing the locking pin assembly;
a connecting piece, being fastened to the other end of the pipe hoop and passing through the ring of the tension brace; and
a fastenings, provided on the end of the connecting piece for tightening the tension brace.

17. A window according to claim 1, wherein at least a locking pin assembly is provided in an end of the other stile, comprising
a base frame with a keyway, having a base formed at the inner part of the keyway and protruded from inside wall;
a pin element with a cavity, provided with
a body for being adapted with the base, on which a protrusion is provided at the outer end for being associated with the outer part of the keyway; and
a body extension, penetrating through a central hole on the top of the base frame;
a spring, provided at the interior of the keyway and pressed on the protrusion of the pin element for resetting the pin element; and
a movable block sliding along the cavity of the pin element, pulled by bracing wires.

18. A window according to claim 17, wherein a handle means for locking is also provided in the stile to adapt with the locking pin assembly for locking the window, comprising
a platen, arranged at a predefined position on the outer surface of the stile and provided with, compring
a recess provided at the front; and
a supporting seat, located at an end of the recess;
a rotary handle for locking, adapted with the recess, fastened to the supporting seat utilizing a axle;
a rotary bracket for arranging the bracing wires connected to the moving block in the cavity of the locking pin assembly, provided at back of the platen and fastened to the ends of the axle outside the supporting seat to be driven by the rotary handle through the axle.

19. A window according to claim 18, wherein the locking pin assembly is provided at top and low ends of the stile respectively.

20. A window according to claim 19, wherein the handle means comprises a roller means, fastened onto the back of the platen via a support and below the rotary bracket, by which a bracing wire connected to the moving block in another locking pin assembly is provided.

21. A window according to claim 20, wherein a torsion-bar spring is provided to depend on the rotary support for resetting the handle.

22. A window according to claim 6, wherein a slab extension is provided on the inner horizontal frame, extending outwards from the inner slab of the horizontal frame.

23. A window according to claim 1, wherein the vertical frame portion comprises two parallel-installed vertical frames.

24. A window according to claim 23, wherein, a fastening support is provided on side slab for the inner frame of one of vertical frames, for fastening the sealing tape and buffering the pushed or pulled sash assembly.

25. A window according to claim 24, wherein a fastening support is provided on side slab for the outer frame of the other vertical frames for fastening the sealing strip and buffering the pushed or pulled sash.

26. A window according to claim 22, wherein an extension part is provided on the rail of the sash assembly for matching with the inner horizontal frame, comprising
the first extension, extending inwards from inner slab of the rail, on which a fastening support is provided for fastening the strip to match with the slab extension of the inner horizontal frame;
the second extension, extending downwards from outer slab of the rail, on which a fastening support is provided for fastening the strip to match with the top or slant part of the outer horizontal frame.

27. A window according to claim 22, wherein an extension part is provided on the rail of the sash assembly for matching with the outer horizontal frame, comprising
the first extension, extending inwards from the inner slab of the rail, on which a fastening support is provided for fastening the strip to match with the slant part of the inner horizontal frame;
the second extension, extending downwards from the out slab of the rail, on which a fastening support is provided for fastening the strip to match with the top slab of said outer horizontal frame.

28. A window according to claim 26, wherein a lap joint is provided on the side portion of the stile provided with a hinge assembly of each sash assembly, on which top wool is provided for sealing the overlapped part of both sash assembly.

29. A window according to claim 28, wherein a fastening support for plastic strip is also provided at the side of one of the lap joints for protecting the lap joints from suffering impaction while closing the window.

30. A window according to claim 1, wherein end cover and main body of one of the stiles is provided to be in movable connection, in which both sides on the end cover have recesses, two slabs of the main body have arris, matching with said recesses respectively.

31. A window according to claim 1, wherein the inner side slab of each horizontal frame and vertical frame of the frame assembly is provided with
a slot, evenly arranged along the length of each frame element;
plastic sectional material, substantially matching with each frame element, on which a bending projection is integrated with its inner side, and is closely coupled with the slot utilizing rolling technology.

32. A window according to claim 31, wherein the inner side slab of each stile and rail of the sash assembly is respectively provided with
a slot, evenly distributed along the length of the stile/rail;
plastic sectional material, substantively matching with each stile/rail, on which a bending projection is integrated with and is closely coupled with the slot utilizing rolling technology.

33. A window according to claim 32, wherein a pressure element is in lock joint with the plastic sectional material for compacting glass medium thereof.

34. A window according to claim 32, wherein, a lap joint is provided on the plastic sectional material of one of the stiles.
